(19) United States
(12) Patent Application Publication
(10) Pub. No.: US 2010/0031142 A1
(43) Pub. Date: Feb. 4, 2010

(54) CONTENT SUMMARIZING SYSTEM, METHOD, AND PROGRAM

(75) Inventor: Kentaro Nagatomo, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/446,923

(22) PCT Filed: Oct. 17, 2007
(86) PCT No.: PCT/JP2007/070248

§ 371 Date: Apr. 23, 2009

(30) Foreign Application Priority Data
Oct. 23, 2006 (JP) 2006-287562

(51) Int. Cl. G06F 17/20; G06F 17/27; G10L 15/26

(52) U.S. Cl. 715/254; 704/9; 704/235; 704/E15.043

(57) ABSTRACT

Disclosed is a summarizing system including a speech input unit, an important portion indication unit, an important section estimation unit, a speech recognition unit, and txt summarization unit. The summarizing system captures a speech section, which is included in a speech received by the speech input unit and includes a portion specified by the important portion indication unit, as a section necessary for a summary. After estimating an appropriate section by the important section estimation unit, the summarizing system recognizes a speech considering the estimated section and performs text summarization.

### CROSS-REFERENCE TO RELATED APPLICATIONS

Related Application

The present application is the National Phase of PCT/JP2007/070248, filed Oct. 17, 2007, which is based upon and claims priority from Japanese patent application 2006-287562 (filed on Oct. 23, 2006) the content of which is hereby incorporated in its entirety by reference into this application.

### TECHNICAL FIELD

The present invention relates to a system, a method, and a program for summarizing content, and more particularly to a system, a method, and a program that are advantageously applicable to a response that summarizes speech content from a speech signal.

### BACKGROUND ART

An example of a conventional utterance content summarizing system is disclosed in Patent Document 1. As shown in FIG. 1, this conventional utterance content summarizing system comprises a speech input unit 101, a speech recognition unit 102, and a text summarization unit 103.

The conventional speech content summarizing system having the configuration shown in FIG. 1 operates as follows.

First, the speech signal from the speech input unit 101 is converted to a text using the speech recognition unit 102.

Next, the converted text is summarized by some text summarization means to create a summarized text. Various known techniques, such as those described in non-Patent Document 1, are used to perform text summarization.

Patent Document 1: Japanese Patent Publication Kokai JP-A No. 2000-010578

Non-Patent Document 1: Manabu Okumura, Hidetsugu Nanba “Automated Text Summarization: Survey”, Natural language processing, Vol. 6, No. 6, pp. 1-26, 1999

### SUMMARY

All the disclosed contents of Patent Document 1 and non-Patent Document 1 given above are hereby incorporated by reference into this specification. The following analysis is given by the present invention.

The conventional system shown in FIG. 1 has the following problems.

A first problem is that it is impossible for the conventional text-summarizing technique to summarize, with sufficient quality, a text which has a complex, diversified structure such as that of a relatively long speech or a natural dialog between persons.

The reason is that the conventional summarization algorithm is designed to provide sufficient quality only for a text that is simple in structure, clear in features, and relatively short in length. So, it is practically impossible to summarize a text, which has a complex, diversified structure, with sufficient quality.

The following gives two examples of typical conventional summarization algorithms.

The first algorithm is the method described in Patent Document 1. In this method, a list of all assumed structures with regard to a summarization source text is prepared in advance and, if a match occurs with one of the structures, a summarized text is generated using the conversion rule which is related to the structure.

For example, assume that a structure indicating that “department” and “name” are close to each other is registered in advance and that the summary generation rule applied to this case generates “department name”. In this case, this summary generation rule generates a summarized text “Business Sato” in response to an input text of “Sato of Business department”.

For this first algorithm to be sufficiently practical, the following requirements must be satisfied.

The structure of an input text is so simple that can be written as described above, and

The text structure is not so diversified that thorough registration thereof can be made in advance.

In other words, this algorithm is not practical for an input that has a complex and diversified structure.

A second algorithm is a technique described in Non-Patent Document 1. That is, a text is divided into plural parts, and the level of importance is calculated for each part based on some criterion.

Parts are removed repeatedly from parts in ascending order of the level of importance, beginning with the least important part, until the size of the summarized text becomes necessary and sufficient.

By doing so, a sufficiently small text (summarized text) composed only of important parts of the whole text can be produced.

According to Non-Patent Document 1, the level of importance is calculated considering a combination of the following factors included in the part.

Number of important words;

Sum of levels of importance of words;

Logical weighting of parts indicated by connection word, etc.

Knowledge about the general sentence structure such as a header, the beginning of a sentence, the end of a sentence, etc.

However, in the technique according to the second algorithm, since each of the text parts is first converted to a measure one dimension, which the level of importance, to determine if the text part is required or not, it is difficult to generate a summary appropriate to a non-uniform text.

For example, when a text includes the discussion of two subjects and the amount of the description of the first subject is significantly larger than the amount of the description of the second subject, the summarized text tends to include a larger amount of description of the first subject.

In a natural dialog speech between persons such as that in a meeting or an over-the-counter service, information on various subjects are exchanged in one dialog.

In this case, the amount of a speech about information well-known to all the participants in the dialog gets smaller regardless of the level of importance of the information.

On the other hand, the amount of information which is not so important but with which some participants are not familiar tends to increase and, as a result, it is often judged that the level of importance of the information is high.

So, the second algorithm is not sufficient either for summarizing a long speech or a natural dialog between persons.

A second problem is that, in a case where a mechanism is prepared that allows a user to instruct an important portion in a speech, it is difficult to specify an appropriate portion if the speech is given in real time.

For example, this problem is apparent, when an important portion is specified while a conversation is being carried out between persons. In such a case, when a person hears a speech, it is apparently only a short time after the speech of the part is given that the person can understand the meaning of the speech and can judge the importance level of the meaning of the speech relative to the whole conversation or whether or not the meaning of the speech should be included in the summary.

Therefore, it is an object of the present invention to provide a speech content summarizing system that can produce a practically sufficient summary even when the speech includes a relatively long speech or a natural dialog between persons.

It is another object of the present invention to provide a speech content summarizing system that enables the user to specify an appropriate portion when a mechanism is prepared that allows the user to instruct an important portion of a conversation, even if the speech of the conversation is supplied in real time.

To solve one or more of the problems described above, the invention is summarized as follows.

According to the present invention, there is provided a content summarizing system comprising:

a content input unit that receives content presented in association with an elapse of time;

a text extraction unit that extracts text information from content input by the content input unit;

an important portion indication unit that indicates an important portion; and

a synchronization unit that synchronizes the content received by the content input unit with the important portion indicated by the important portion indication unit.

In the present invention, the content summarizing system further comprises

an important section estimation unit that performs predefined, predetermined processing for text information obtained by the text extraction unit and estimates an important section corresponding to the important portion indication.

In the present invention, the content summarizing system further comprises

a text summarization unit that performs text summarizing processing for text information, obtained by the text extraction unit, with reference to an important section obtained by the important section estimation unit, and outputs a summarized text.

In the present invention, the text summarization unit performs summarizing processing with priority given to text obtained from content corresponding to an important section which has been estimated by the important section estimation unit.

In the present invention, content received by the content input unit includes a speech and the text extraction unit comprises a speech recognition unit that extracts text information by performing speech-recognition of a speech signal received as content.

In the present invention, the text extraction unit may comprise one of a unit that extracts character information, given as content, as text information;

a unit that extracts text information by reading meta information from a multimedia signal including meta information;

a unit that extracts text information by reading a closed caption signal from an image signal; and

a unit that extracts text information by image-recognizing characters included in a video.

In the present invention, the important section estimation unit may include a section of content as an estimation section, the section of content having text information near an important portion of the content, the important portion of the content received from the important portion indication unit.

In the present invention, content from the content input unit includes a speech, and the important section estimation unit may include an utterance as an estimation section, the utterance being located bin the neighborhood of an important portion of the speech, the important portion of the speech received from the important portion indication unit.

In the present invention, if there is no text information at a content position corresponding to the important portion indication, the important section estimation unit may use a section of content having immediately preceding text information as an estimation section.

In the present invention, content from the content input unit includes a speech and, if there is no sound at a speech position corresponding to the important portion indication, the important section estimation unit may use an immediately preceding speech section as an estimation section.

In the present invention, when a section of content, which has text information preceding or following content corresponding to an important portion indication, is included into the estimation section, the important section estimation unit may include a preceding section into the estimation section by priority.

In the present invention, when a speech preceding or following a speech corresponding to the important portion indication is included, the important section estimation unit may include the preceding speech into the estimation section by priority.

In the present invention, when a text preceding or following content corresponding to the important portion indication includes a predefined word, the important section estimation unit may expand or contracts the estimation section according to a predetermined algorithm.

In the present invention, the content summarizing system may further comprise a summarization result evaluation unit that analyzes an output of the text summarization unit and evaluates an accuracy of a summary, wherein the important section estimation unit performs expansion or compression of one or more of extracted important sections according to the summary result evaluation.

In the present invention, a summary ratio calculation unit, which analyzes an output of the text summarization unit and calculates a summary ratio, may be provided as the summarization result evaluation unit and if the summary ratio is not lower than a predetermined value, the important section estimation unit contracts one of extracted important sections and, if the summary ratio is not higher than a predetermined value, expands one of extracted important sections.

A system according to the present invention comprises:

a speech input unit that receives a speech signal;

a speech recognition unit that recognizes a speech and outputs a text of the speech recognition result;

a speech output unit that outputs a speech received by the speech input unit;

an important portion indication unit that instructs an important portion;

a synchronization unit that acquires, from the speech recognition unit, a text of the speech recognition result corresponding to a timing of an important portion entered by the important portion indication unit;

an important section estimation unit that sets an initial value of an important section based on a text of the speech recognition result corresponding to the timing of an important portion acquired by the synchronization unit; and

a text summarization unit that performs text summarizing processing for a text of the speech recognition result output by the speech recognition unit, in consideration of the important section output by the important section estimation unit, and outputs the summarized text.

A method according to the present invention is a content summarizing method executed by a computer to extract text information from received contents for creating a summary, the content summarizing method comprising:

a step of receiving an important portion indication;

a step of estimating an important section, corresponding to the important portion, from text information extracted from the received content; and

a step of creating a summarized text considering the important section.

A method according to the present invention comprises:

a content receiving step of receiving content provided sequentially as time elapses;

a text extraction step of extracting text information from content received by the content receiving step;

an important portion indication step of specifying an important portion; and

a step of synchronizing the content received by the content receiving step with the important portion received by the important portion indication step.

The method according to the present invention may further comprise

an important section estimation step of performing predefined, predetermined processing for text information obtained by the text extraction step for estimating an important section corresponding to the important portion indication.

The method according to the present invention may further comprise

a text summarization step of performing text summarizing processing for text information, obtained by the text extraction step, by referencing an important section obtained by the important section estimation step, for outputting a summarized text.

In the present invention, the text summarization step may perform summarizing processing with priority given to text obtained from content corresponding to an important section estimated by the important section estimation step.

A program according to the present invention causes a computer, which performs content text summarization in which text information is extracted from received content for creating a summary, to execute:

a processing of receiving an important portion indication;

a processing of estimating an important section, corresponding to the important portion, from text information extracted from the received content; and

a processing of creating a summarized text considering the important section. The program is stored in a computer-readable recording medium.

A program according to the present invention further causes a computer to execute:

a content receiving processing of receiving content provided sequentially as time elapses;

a text extraction processing of extracting text information from the content received by the content receiving process;

an important portion indication processing of specifying an important portion; and

a processing of synchronizing the content received by the content receiving process with the important portion received by the important portion indication process. The program is stored in a computer-readable recording medium.

The program according to the present invention may further cause the computer to perform an important section estimation process of performing predefined, predetermined processing for text information, obtained by the text extraction process, for estimating an important section corresponding to the important portion indication.

The program according to the present invention may further cause the computer to perform a text summarization process of performing text summarizing processing for text information, obtained by the text extraction process, by referencing an important section, obtained by the important section estimation step, for outputting a summarized text.

In the program according to the present invention, the text summarization process may perform summarizing processing with priority given to text obtained from content corresponding to an important section estimated by the important section estimation process.

A content summarizing system according to the present invention, a system for creating a summary of received content, comprises a unit that receives an important portion indication; and unit that analyzes the content and, when the important portion indication is received, generates a summary including a part of content corresponding to the received important portion indication wherein a summary including a content part, corresponding to the important portion indication, is generated from the content presented or reproduced in real time.

In the present invention, the content summarizing system may analyze the content for extracting text information and generate a summary including text information corresponding to the reception of the important portion indication.

In the present invention, the content summarizing system may perform speech-recognition of speech information on the content, convert the recognized speech to a text and generate a summary including text information on the speech recognition result corresponding to the reception of the important portion indication.

In the present invention, the content summarizing system may speech-recognize speech information on the content, convert the recognized speech to a text and generate a summary including a speech information text or a speech information text and images corresponding to the reception of the important portion indication.

In the present invention, the content summarizing system may receive information on a content summary creation key as the input of the important portion indication, analyze the content, and output a part of the content, including the information corresponding to the key, as a summary.

In the present invention, the content summarizing system may analyze image information constituting the content, extract a text and generate the text as a summary including the image information corresponding to the key received as the important portion indication.

The present invention provides a speech content summarizing system that can generate a practically sufficient summary even for a relatively long speech or a natural dialog speech between persons.

The reason is that system according to the present invention allows a user to specify a part of a speech, which is considered appropriate, even for a speech that has a complex structure or an unknown structure, thus increasing the accuracy of the text summary.

The present invention provides a speech content summarizing system that allows a user to appropriately specify an important portion of the speech even when the speech is received in real time.

The reason is that, because an important portion is specified as a “point” and this point is automatically expanded to a “section” in the present invention, the user is only required to take an action to specify an important portion only at the time the user hears a speech that is considered important.

In addition, because the important section estimation is made in this present invention also for the speech before the time the important portion is specified, the important section estimation unit selects an already-reproduced, past speech as an important section and adds the selected important section to the summary.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing the configuration of a system in Patent Document 1.

FIG. 2 is a diagram showing the configuration of a first embodiment of the present invention.

FIG. 3 is a flowchart showing the operation of the first embodiment of the present invention.

FIG. 4 is a diagram showing the configuration of a second embodiment of the present invention.

FIG. 5 is a flowchart showing the operation of the second embodiment of the present invention.

FIG. 6 is a diagram showing the configuration of one example of the present invention.

### PREFERRED MODES

Next, the present invention will be described in detail below with reference to the drawings.

According to the present invention there is provided a content summarizing system which comprises: a content input unit that receives content provided in association with an elapse of time; a text extraction unit that extracts text information from content received by the content input unit; an important portion indication unit that receives an indication of an important portion; and a synchronization unit that synchronizes the content received by the content input unit with the important portion indicated by the important portion indication unit. In an exemplary embodiment in which a content summarizing system of the present invention is applied to a speech content summarizing system, there are provided a speech input unit (201) which corresponds to the content input unit, an important portion indication unit (203), a synchronization unit (204), an important section estimation unit (205), a speech recognition unit (202) which corresponds to the text extraction unit, and a text summarization unit (206). A speech section which is included in a speech received by the speech input unit and includes a portion specified by the important portion indication unit (203), is grasped as a section needed for summarization, and an appropriate section is estimated by the important section estimation unit (205). After that, in consideration of the estimated section, the speech is recognized and the text summarization operation is performed. The system separately accepts a minimum information input from the user to have any user-specified portion of a speech included in the summary.

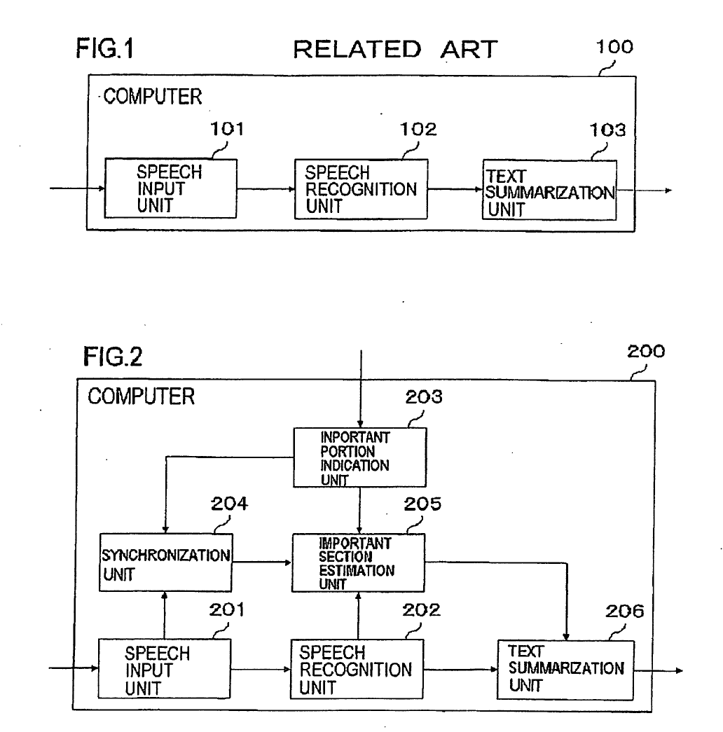

FIG. 2 is a diagram showing the configuration of a first exemplary embodiment of the present invention. The first exemplary embodiment of the present invention is a speech content summarizing system that makes it possible to make a summary include any user-specified speech portion.

Referring to FIG. 2, a computer 200 that operates under program control in a speech content summarizing system in the first exemplary embodiment of the present invention comprises a speech input unit 201, a speech recognition unit 202, an important portion indication unit 203, a synchronization unit 204, an important section estimation unit 205, and a text summarization unit 206. The following describes the general operation of those unit.

The speech input unit 201 captures the speech waveform signal, which is to be summarized, as digital data (digital signal sequence related to the passage of time).

The speech recognition unit 202 performs speech recognition processing for the digital signal sequence received by the speech input unit 201 and outputs the resulting text information. At this time, it is assumed that the text, output as a recognition result, is obtained in such a way that an original speech waveform is synchronized with the time information output by the speech recognition unit 202.

The important portion indication unit 203 sends an important portion indication signal to the synchronization means 204 and to the important section estimation unit 205 based on a user operation.

The synchronization unit 204 performs adjustment so that the speech waveform data obtained by the speech input unit 201 and the important portion indication signal obtained by the important portion indication unit 203 can synchronize.

For example, if the time at which speech waveform data is captured by the speech input unit 201, matches the time at which an important portion indication signal is received from the important portion indication unit 203, the synchronization unit 204 judges that the speech waveform data and an important portion indication signal, both of which are received the same length of relative time later, synchronize with each other.

Because, in this case, the speech waveform data received by the speech input unit 201 and the recognition result output by the speech recognition unit 202 synchronize with each other, the synchronization between the important portion indication signal, received by the important portion indication unit 203, and the speech recognition result is also maintained indirectly.

Based on the important portion indication signal received by the important portion indication unit 203 and its time information, the important section estimation unit 205 performs predefined, predetermined processing for the speech recognition result text, which corresponds to the speech output by the speech input unit 201 around that time and is produced by the speech recognition unit 202, to estimate a speech section that is estimated to be specified by the user via the important portion indication unit 203.

The text summarization unit 206 performs predefined summarizing processing for the speech recognition result text, produced by the speech recognition unit 202, while considering the important section estimated by the important section estimation unit 205, and outputs the resulting summarized text.

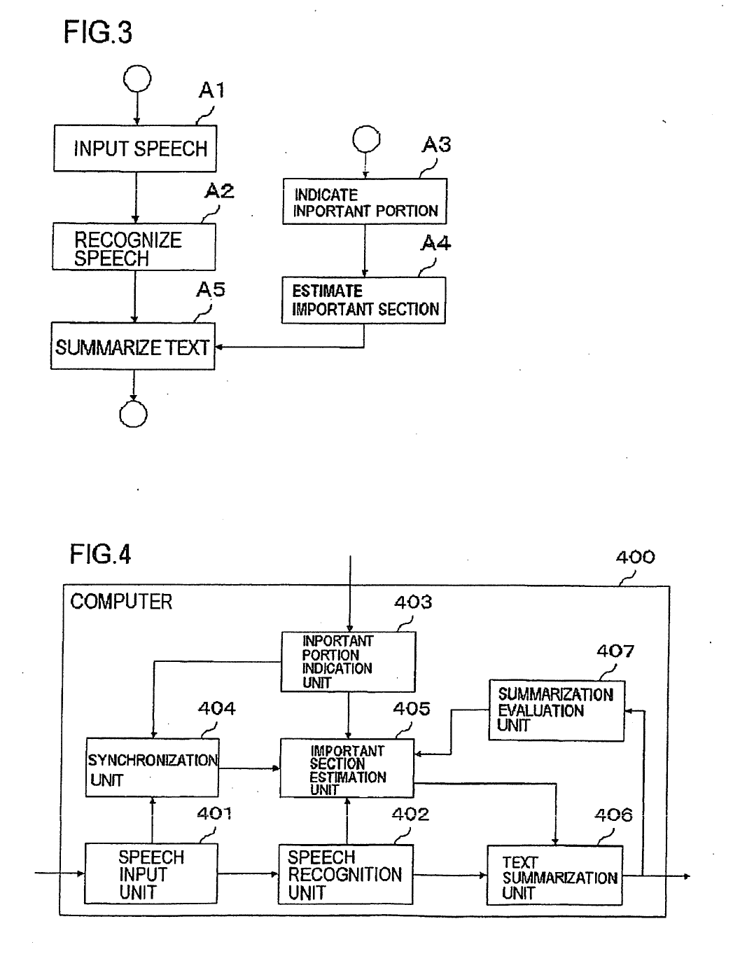

Next, the following describes the general operation of this exemplary embodiment in detail with reference to FIG. 2 and the flowchart in FIG. 3.

First, the speech signal is received by the speech input unit 201 (step A1 in FIG. 3).

Next, the speech recognition unit 202 recognizes the speech of the received speech signal and outputs a speech recognition result text (step A2).

The user sends the important portion indication signal using the important portion indication unit 203 (step A3). In response to this signal, the important section estimation unit 205 starts the operation and, via the synchronization unit 204, acquires a time corresponding to the important portion indication signal as well as the speech recognition result text at or around the time and, with this acquired time and text as the input, estimates an important section (step A4).

Finally, the text summarization unit 206 performs the text summarizing processing for the speech recognition result text in consideration of the estimated important section and outputs the speech content summarized text (step A5).

Next, the following describes the effect of this exemplary embodiment.

In this exemplary embodiment, the user can enter the important portion indication signal to provide a designation, which specifies that importance be given to a portion of the speech, to the text summarizing processing. This allows any user-specified portion of the speech to be included in the summary, regardless of the text summarization quality or the complexity of the received speech or the sentence structure.

In this exemplary embodiment, because the portion of the speech not only at, but also before and after, a point in time when the important portion indication signal is received, is included in the section (important section) to which importance is given during summarization, the user can include any user-requested portion of the speech in the summary simply by specifying, not a section, but a point in time.

At the same time, even if there is a short time lag from the time a speech is spoken to the time the user specifies the speech, the speech can be included in the summary.

That is, especially in a situation where a speech is received in real time, the user can easily specify an important portion.

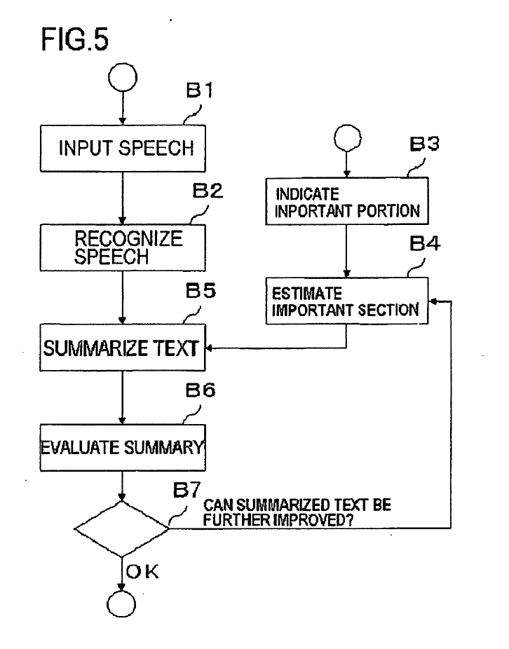

Next, a second exemplary embodiment of the present invention will be described. FIG. 4 is a diagram showing the system configuration of the second exemplary embodiment of the present invention. Referring to FIG. 4, a computer 400 that operates under program control in the second exemplary embodiment of the present invention comprises a speech input unit 401, a speech recognition unit 402, an important portion indication unit 403, a synchronization unit 404, an important section estimation unit 405, a text summarization unit 406, and a summarization evaluation unit 407.

The configuration is the same as that in the first exemplary embodiment described above except that the summarization evaluation unit 407 is newly added. In the description below, the difference from the first exemplary embodiment is described. The description of the same components as those in the first exemplary embodiment is omitted as necessary to avoid duplicate description.

The important section estimation unit 405 performs almost the same operation as that of the important section estimation unit in the first exemplary embodiment described above. That is, based on the important portion indication signal from the important portion indication unit 403 and its time information, the important section estimation unit 405 performs predetermined processing for the speech recognition result text, which corresponds to the speech output by the speech input unit 401 around that time and has been obtained by the speech recognition unit 402, to estimate a speech section that is supposed to be specified by the user via the important portion indication.

In this exemplary embodiment, the important section estimation unit 405 receives a summary evaluation from the summarization evaluation unit 407 and further estimates the important section based on the evaluation.

The summarization evaluation unit 407 evaluates the summarized text which has been generated by the text summarization unit 406, based on the predefined criterion and, if it is determined that the summarized text can be further improved, gives necessary information to the important section estimation unit 405 for estimating the important section again.

Next, the following describes the general operation of this exemplary embodiment in detail with reference to FIG. 4 and the flowchart shown in FIG. 5.

The flow to the time the speech data, received from the speech input unit 401, is summarized by the text summarization unit 406 by referring to the important portion indication signal received from the important portion indication unit 403 is the same as the flow of the processing procedure in the first exemplary embodiment shown in FIG. 3 (steps B1-B5 in FIG. 5).

In this exemplary embodiment, the following operation is further performed.

The summarized text generated by the text summarization unit 406 is evaluated by the summarization evaluation unit 407 according to the predetermined criterion (step B6). If it is judged as a result of this evaluation that the summarized text can be improved (step B7), control is passed back to step B4 for restarting the important section estimation unit 405.

For example, the summarization evaluation unit 407 uses a summary ratio as the evaluation criterion. The summary ratio refers to the ratio of the summarized text size to the source text size (in many cases, the number of bytes or characters is used).

If the summary ratio is sufficiently lower than the predetermined threshold, the important section estimation unit 405 is started to make the important section larger; conversely, if the summary ratio is sufficiently higher than the predetermined threshold, the important section estimation unit 405 is started to make the important section smaller.

Next, the following describes the effect of this exemplary embodiment.

The important section estimation made by the important section estimation unit 205 in the first exemplary embodiment described above is based primarily on an important portion indication received by the important portion indication unit 203. In this case, the section estimation is made based only on the local information.

In contrast, the important section estimation unit 405 in the second exemplary embodiment of the present invention uses the information, given by the summarization evaluation unit 407, to make the section estimation, surveying the entire summary text, thus producing a higher accuracy summarized text.

Although the speech recognition unit is used in the examples in the first and second exemplary embodiments as the text extraction unit that extracts text information from the received content (speech), the present invention is not limited to this configuration.

In addition to the speech recognition unit, any text extraction unit capable of extracting a text may be used as a device for extracting a text.

The text extraction unit extracts character information, which is given as content, to produce text information. In another case, the text extraction unit extracts text information by reading meta information from a multimedia signal that includes meta information. In still another case, the text extraction unit extracts text information by reading the closed caption signal from the image signal.

In still another case, the text extraction unit extracts text information by performing image-recognition of characters included in a video. The following describes the exemplary embodiments using examples.

### EXAMPLES

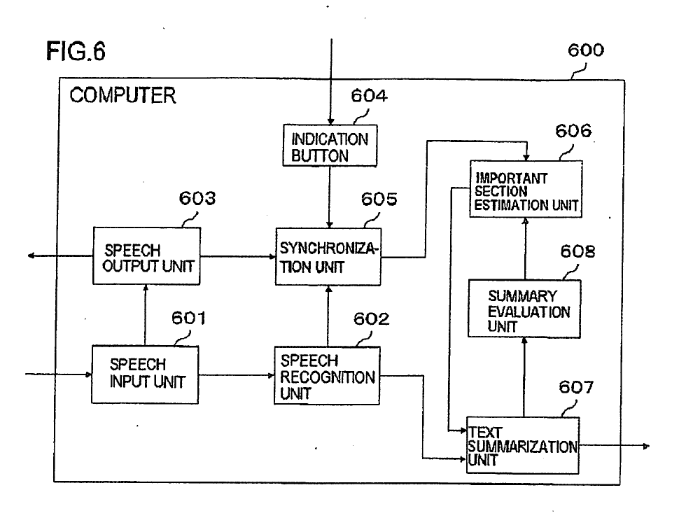

FIG. 6 is a diagram showing the configuration of one example of the present invention. As shown in FIG. 6, a computer 600 in this example comprises a speech input unit 601, a speech recognition unit 602, a speech output unit 603, a indication button 604, a synchronization unit 605, an important section estimation unit 606, a text summarization unit 607, and a summary evaluation unit 608.

A speech waveform is input from the speech input unit 601. This speech is sent immediately to the speech recognition unit 602. The speech recognition unit 602 performs matching processing between predefined models and the speech and produces a speech recognition result text.

On the other hand, the speech waveform input from the speech input unit 601 is sent immediately to the speech output unit 603 and the user hears the speech via a speaker.

The user presses the indication button 604 at any time he or she wants while hearing the speech.

The synchronization unit 605, which finds that the indication button 604 was pressed, first finds the speech corresponding to the time the button was pressed.

If the speech input from the speech input unit 601 is sent immediately to the speech output unit 603 and the user hears the speech, the speech corresponding to the time the button was pressed is the speech that was input at that time.

In addition, from the output of the speech recognition unit 602, the synchronization unit 605 obtains the speech recognition result text for the speech corresponding to the time the button was pressed.

The important section estimation unit 606 sets the initial value of the important section, based on the recognition result text corresponding to the time at which the indication button 604 was pressed and which was acquired by the synchronization unit 605. For example, one speech section (continuous non-noise section) including the recognition result text is set as the initial value of the important section.

Alternatively, the speech section corresponding to a word, a phrase, or a sentence (a sequence of words separated by punctuation marks or postpositional words) including the recognition result text may also be set as the initial value of the important section.

At this time, non-text information that can be acquired from the speech recognition unit 602 may also be used. For example, since a recognition result text not satisfying the predefined recognition degree is likely to be generated by a noise, the speech section corresponding to the text is not used as the initial value setting of the important section.

The important section estimation unit 606 performs expansion or compression of the important section, as necessary. An example of the judgment criterion for expansion and contraction is to check if a predetermined vocabulary occurs in the current important section.

For example, if no function word is included in the recognition result text obtained from the important section, the sections preceding and following the important section are incorporated in the important section.

Conversely, if the recognition result text obtained from the important section includes a filler such as “Uh”, the speech section corresponding to this filler should be deleted from the important section.

If the content to be summarized is restrictive to some degree, the criteria such as

whether or not predefined reference terms (“It is”, “That is”, “I mean”, or “I'd like to make sure that”) are present, or

whether or not more restrictive words, such as a telephone number, a name, an organization name, or a product name are present, may be used to estimate a more accurate important section.

As another judgment criterion, whether or not an effective speech recognition text is included in the important section may be used.

Depending upon the time at which the indication button 604 is pressed, an effective recognition result text may not be obtained in some cases because the speech is a noise.

In such a case, the speech section, which immediately precedes or immediately follows the speech and includes a recognition result text, is obtained as the important section.

Which speech section, immediately preceding or immediately following, is selected should be decided according to the following criteria:

(a) select the important section nearer to the time the button was pressed;

(b) select the important section that has a higher level of general importance by comparing the attribute of the text of the preceding section with the attribute of the text of the following section (whether or not the predefined level of importance, the predefined part of speech, or a syntactical keyword such as “therefore” is included); or

(c) select the speech section that has a higher accuracy of the speech recognition processing.

Based on the heuristic that the time the user presses the indication button is a little later than the time the user hears a desired speech, the preceding speech section may always be selected. It is of course possible to select both the preceding and following sections as the important sections.

The important section is expanded or contracted, for example, for the length of the speech, corresponding to a predefined time or corresponding to a predetermined number of words/sentences, preceding or following the section.

For example, when the section is expanded, one preceding speech and one following speech are incorporated in the current section.

Another method for expanding and contracting the important section is that, when a predefined keyword occurs near the initial value of the important section (this is also defined by the time or the number of speeches), the important section is expanded or contracted to a speech section to which one of the words, known to co-occur with the keyword, belongs.

For example, if “telephone number” occurs in an important section and if a numeric string that look likes a telephone number occurs in the immediately following speech, the sections including that speech section are incorporated in the important section.

Although the scenes to which this method is applicable are limited because the heuristic is required, this method ensures high accuracy.

A still another method for expanding and contracting the important section is that, when a predefined reference term (“It is”, “That is”, “I mean”, or “I'd like to make sure that”) occurs near the initial value of the important. section, the immediately following speech section is incorporated in the important section.

Although very similar to the method in which a co-occurrence keyword is used, this method is widely applicable because the knowledge used is relatively versatile.

A still another possible method for expanding and contracting the important section is that, when a predefined acoustically-characterized phenomenon (change in power, pitch, or speech speed, etc.) is found near the important section, the speech sections near the important section are incorporated in the important section.

For example, there is a high possibility that a speech spoken with a power higher than a predefined threshold indicates the speaker's intention to emphasize the speech content.

The important section estimation unit 606 notifies the text summarization unit 607 that a section, which finally seems to be most suitable, is the important section.

In some cases, the section that is set as the initial value is output as the most suitable important section.

The text summarization unit 607 performs the text summarizing processing for the speech recognition result text, which is output by the speech recognition unit 602, in consideration of the important section output by the important section estimation unit 606, and outputs a summarized text.

A text summarization method considering the important section is that, for example, when the level of importance of each part of the text is calculated, a bias is added to the level of importance of the text part corresponding to the section, which has been estimated by the important section estimation unit 606 as the important section, as for usual text summarization.

Another text summarization method which takes into consideration the important section is, for example, to perform text summarization using only one or more sections obtained as important sections. In this case, the important section estimation unit 606 should preferably adjust the estimation operation during the section estimation in such a way that a slightly larger section is produced as a result of estimation.

The summary evaluation unit 608 evaluates a summarized text, output by the text summarization unit 607, according to a predetermined criterion.

If the summarized text does not satisfy the predetermined criterion, the important section estimation unit 606 performs the operation again to expand/contract the important section and sends the result to the text summarization unit 607. Repeating this operation produces a good-quality summarized text.

As for the repetition number, the following may be employed:

a method of repeating until the summarized text satisfies a predetermined criterion,

a method of repeating until a predetermined processing time elapses, or

a method of repeating a predetermined number of times is reached.

The criterion for evaluating a summarized text is, for example, a summarization ratio.

The summarization ratio used in text summarization refers to the ratio of the summarized text size to the original text size. The size is usually expressed in the number of characters.

In this exemplary embodiment, the ratio between the total number of characters of the speech recognition result text produced as a result of the speech recognition by the speech recognition unit 602 for all speech sections received from the speech input unit 601 and the number of characters of the summarized text output by the text summarization unit 607 is used.

If the summarization ratio is used as the evaluation criterion and if the summarization ratio of the summarized text output by the text summarization unit 607 is higher than the predefined target summarization ratio, the important section should be decreased; conversely, if the summarization ratio is significantly lower than the target summarization ratio, the important section should be increased.

The system according to the present invention generates a summarized text more appropriate for a natural speech between persons or for a relatively long speech. So, the system is applicable, for example, to the creation of:

conference minutes;

lecture auditing record;

memo of telephone conversation;

record document; or

collection of TV program scenes.

The present invention is applicable not only to text summarization but also to a text search. In this case, the text summarization unit 406 in FIG. 4 is replaced by search query generation means.

The search query generation means performs the operation in which independent words are extracted from the text included in an important section and the logical product of those independent words is generated as a search query.

After that, specifying the search query for a search engine provides the user with an easy-to-operate search function.

Search result evaluation means, if provided instead of the summarization evaluation unit 407 in FIG. 4, allows the important section estimation to be repeated (to expand the section) if no search result is found in the estimated important section.

In the present invention, it is also possible to speech-recognize the speech information on content for converting the recognized speech to a text and to generate a summary in which the text of the speech recognition result corresponding to the specification of an important portion and the image information corresponding to the speech are included. In the present invention, it is also possible that the key information (timing information, text information, attribute information) on content summary creation is input as the specification of an important portion, the content is analyzed, and a part of the content including information corresponding to the key is output as a summary.

The exemplary embodiments and the examples may be changed and adjusted in the scope of all disclosures (including claims) of the present invention and based on the basic technological concept thereof. In the scope of the claims of the present invention, various disclosed elements may be combined and selected in a variety of ways.

What is claimed is:

1. A content summarizing system comprising:
a content input unit that receives content provided in association with an elapse of time;
a text extraction unit that extracts text information from content received by the content input unit;
an important portion indication unit that receives an indication of an important portion; and
a synchronization unit that synchronizes content received by the content input unit with an important portion indication received from the important portion indication unit.

2. The content summarizing system according to claim 1, further comprising
a unit that estimates an important section corresponding to the important portion for text information extracted from the received content.

3. The content summarizing system according to claim 1, further comprising
a text summarization unit that performs text summarizing processing and outputs a summarized text.

4. A content summarizing system comprising:
a content input unit that receives content provided sequentially as time elapses;
a text extraction unit that extracts text information from content received by the content input unit; and
a text summarization unit that performs text summarizing processing and outputs a summarized text, the system further comprising:
an important portion indication unit that indicates an important portion; and
a synchronization unit that synchronizes content supplied by the content input unit with an important portion supplied by the important portion indication unit.

5. The content summarizing system according to claim 4, further comprising
an important section estimation unit that performs predefined, predetermined processing for text information obtained by the text extraction unit and derives an important section which is estimated to be instructed as the important portion.

6. The content summarizing system according to claim 5, wherein the text summarization unit performs text summarizing processing for text information obtained by the text extraction unit, with reference to an important section, obtained by the important section estimation unit, and outputs the summarized text.

7. The content summarizing system according to claim 5, wherein the text summarization unit performs summarizing processing with priority given to text obtained from content corresponding to an important section estimated by the important section estimation unit.

8. The content summarizing system according to claim 1, wherein content received by the content input unit includes a speech, and
the text extraction unit comprises
a speech recognition unit that extracts text information by performing speech-recognition of a speech signal received as content.

9. The content summarizing system according to claim 1, wherein the text extraction unit comprises one of:
a unit that extracts character information, given as content, as text information;
a unit that extracts text information by reading meta information from a multimedia signal including meta information;
a unit that extracts text information by reading a closed caption signal from an image signal; and
a unit that extracts text information by performing image-recognition of characters included in a video.

10. The content summarizing system according to claim 5, wherein the important section estimation unit causes a section of content to be included in an estimation section, the section of content having text information in the neighborhood of an important portion of the content, the important portion of the content being supplied from the important portion indication unit.

11. The content summarizing system according to claim 5, wherein content from the content input unit includes a speech, and
the important section estimation unit causes an utterance to be included in an estimation section, the utterance being in the neighborhood of an important portion of the speech, the important portion of the speech being supplied from the important portion indication unit.

12. The content summarizing system according to claim 5, wherein, if there is no text information at a content position corresponding to the important portion indication, the important section estimation unit uses a section of content having immediately preceding text information as an estimation section.

13. The content summarizing system according to claim 5, wherein content from the content input unit includes a speech, and
if there is no sound at a speech position corresponding to the important portion indication, the important section estimation unit uses an immediately preceding speech section as an estimation section.

14. The content summarizing system according to claim 10, wherein, when a section of content, which has text information preceding or following content corresponding to an important portion indication, is included into the estimation section, the important section estimation unit includes a temporally preceding section, by priority.

15. The content summarizing system according to claim 11, wherein, when a speech preceding or following a speech corresponding to the important portion indication is included into the estimation section, the important section estimation unit includes the preceding speech by priority.

16. The content summarizing system according to claim 5, wherein, when a text preceding or following content corresponding to the important portion indication includes a predefined word, the important section estimation unit performs expansion or compression of the estimation section.

17. The content summarizing system according to claim 5, further comprising
a summarization result evaluation unit that analyzes an output of the text summarization unit and evaluates an accuracy of a summary, wherein
the important section estimation unit performs expansion or compression of one or more of extracted important sections according to the summary result evaluation.

18. The content summarizing system according to claim 17, further comprising
a summary ratio calculation unit which analyzes an output of the text summarization unit and calculates summary ratio, is provided as the summarization result evaluation unit, and
if the summary ratio is not lower than a predetermined value, the important section estimation unit contracts one of extracted important sections and, if the summary ratio is not higher than a predetermined value, expands one of extracted important sections.

19. The content summarizing system according to claim 1, further comprising:
a speech input unit that receives a speech signal as content; and
a speech recognition unit that recognizes a received speech signal from the speech input unit, for outputting a text of the speech recognition result, wherein
a speech section, which is included in a speech received from the speech input unit and includes a portion specified by the important portion indication unit, is captured as a section necessary for a summary, an appropriate section is estimated by the unit that estimates an important section, a speech is recognized considering the estimated important section and, in addition, text summarization is performed to create a summary of spoken content and, by separately accepting an input of minimum required information from a user, a user-specified speech position is included in the summary.

20. The content summarizing system according to claim 1, further comprising:
a speech input unit that receives a speech signal as content;
a speech recognition unit that recognizes a received speech signal from the speech input unit for outputting a text of the speech recognition result; and
a speech output unit that outputs a speech received from the speech input unit, wherein
the important portion indication unit comprises an operation button by which a user instructs an important portion; and
a synchronization unit that acquires a text of the speech recognition result, corresponding to a time of an important portion entered by the operation button, from the speech recognition unit,
the unit that estimates an important section sets an initial value of an important section based on a text of the speech recognition result corresponding to the timing of an important portion acquired by the synchronization unit, and
the unit that creates a summarized text performs text summarizing processing for a text of the speech recognition result, output by the speech recognition unit considering the important section and outputs a summarized text.

21. A content summarizing method executed by a computer to extract text information from received content for creating a summary, the method comprising:
receiving an important portion indication;
estimating an important section, corresponding to the important portion, from text information extracted from the received content; and
creating a summarized text considering the important section.

22. A content summarizing method comprising:
receiving content provided sequentially as time elapses;
extracting text information from the content;
specifying an important portion; and
synchronizing the content received with the important portion received.

23. A computer-readable recording medium storing a program causing a computer, which performs content text summarization in which text information is extracted from received content for creating a summary, to execute the processing comprising:
receiving an important portion indication;
estimating an important section, corresponding to the important portion, from text information extracted from the received content; and
creating a summarized text considering the important section.

24. The computer-readable recording medium according to claim 23, further causing the computer to perform the processing comprising:
receiving content provided sequentially as time elapses;
extracting text information from the content received;
specifying an important portion; and
synchronizing the content received with the important portion received.
